(19) United States
(12) Patent Application Publication
(10) Pub. No.: US 2005/0007488 A1
(43) Pub. Date: Jan. 13, 2005

(54) Surveillance camera mount assembly

(75) Inventors: James F. Arbuckle, Fresno, CA (US); Craig Andrews, Fresno, CA (US)

Correspondence Address: Paul T. Kashimba, Esq.;Gunster, Yoakley & Stewart, P.A., Suite 1400, 500 East Broward Boulevard, Fort Lauderdale, FL, 33394, US

(73) Assignee: Pelco

(21) Appl. No.: 10/877,438

(22) Filed: Jun. 25, 2004

Related U.S. Application Data
(60) Provisional application No. 60/483,162, filed on Jun. 27, 2003.

(51) Int. Cl. H04N 5/225

(52) U.S. Cl. 348/375

(57) ABSTRACT

A surveillance camera mount assembly for attaching a surveillance camera to a support comprising a surveillance camera housing having a top surface with a plurality of threaded members, a plurality of nuts having threads that mate with the threaded members, and a mount having a mechanical connector for attaching the mount to a support and having a plurality of elongated apertures that align with the plurality of threaded members. The elongated apertures having first and second aperture portions with the first aperture portion being sized so that one of the nuts can pass through it and a second aperture portion being sized so that one of the nuts cannot pass through it.

### CROSS-REFERENCE TO RELATED APPLICATION

This application relates to and claims priority to U.S. Provisional Patent Application Ser. No. 60/483,162, filed Jun. 27, 2003, entitled SURVEILLANCE CAMERA MOUNT ASSEMBLY, the entirety of which is incorporated herein by reference.

### STATEMENT REGARDING FEDERALLY SPONSORED RESEARCH OR DEVELOPMENT

N/A

### BACKGROUND OF THE INVENTION

This invention relates to surveillance systems and, in particular, to a surveillance camera mount assembly and surveillance camera.

Surveillance systems use a variety of surveillance cameras to monitor a location. One type of surveillance camera employs a camera positioned inside a housing and transparent dome structure. This housing is supported at the surveillance location in a hanging or inverted position by a ceiling mount, pole, arm or other support structure. These pendant surveillance cameras are usually mounted by utilizing a threaded pipe section on the housing, which requires the installer to engage the threads of a suspended mount in the threads of the housing. The installer then has to rotate the housing a number of revolutions until the housing is securely attached to the suspended mount. This installation can be difficult to accomplish while standing on a ladder and does not conducive to pre-wiring of the dome since the rotation causes twisting of the wiring and possible damage. In addition, if the dome is a pressurized dome, the installer has to install the dome to the suspended mount before he can make the wire connections and pressurize the dome. Accordingly, it is desirable to have a camera mount assembly that facilitates installation.

### SUMMARY OF THE INVENTION

In accordance with the present invention there is provided a surveillance camera mount assembly for attaching a surveillance camera to a support comprising a surveillance camera housing having a top surface with a plurality of threaded members, a plurality of nuts having threads that mate with the threaded members, and a mount having a mechanical connector for attaching the mount to a support and having a plurality of elongated apertures that align with the plurality of threaded members. The elongated apertures having first and second aperture portions with the first aperture portion being sized so that one of the nuts can pass through it and a second aperture portion being sized so that one of the nuts cannot pass through it.

In addition, the present invention provides a surveillance camera mount assembly for attaching a surveillance camera to a support comprising a surveillance camera housing having a top surface with a plurality of threaded apertures, a plurality of members having threads that mate with the apertures and a head that is larger than the threads, and a mount with a mechanical connector for attaching said mount to a support and a plurality of elongated apertures that align with the plurality of heads of the members. The elongated apertures have first and second aperture portions with the first aperture portion being sized so that one of the heads can pass through it and the second aperture portion being sized so that one of the heads cannot pass through it.

In another embodiment the present invention provides a surveillance camera mount assembly for attaching a surveillance camera to a support comprising a mount having a plurality of apertures and a mechanical connector for attaching said mount to a support, a plurality of threaded members sized so that the threaded portion passes through the apertures, a plurality of nuts having threads that mate with the threaded members, and a housing for a surveillance camera having a plurality of elongated apertures that align with the plurality of threaded members. The elongated apertures having first and second aperture portions with the first aperture portion being sized so that one of the nuts can pass through it and the second aperture portion being sized so that one of the nuts cannot pass through it. The housing has a plurality of threaded apertures positioned below the second aperture portions with threads that mate with the threaded members.

In still another embodiment the present invention provides a surveillance camera mount assembly for attaching a surveillance camera to a support comprising a mount having a plurality of apertures and a mechanical connector for attaching the mount to a support, a plurality of threaded members sized so that the threaded portion passes through the apertures, a plurality of nuts having threads that mate with the threaded members, and a housing for a surveillance camera with a plurality of elongated apertures that align with the plurality of threaded members. The elongated apertures are sized so that the threaded portion of the threaded members can pass through the elongated aperture but the nuts cannot pass through it. The housing has a plurality of threaded apertures positioned below the elongated apertures with threads that mate with the threaded members.

In yet another embodiment, the present invention provides a surveillance camera mount assembly for attaching a surveillance camera to a support comprising a surveillance camera housing with a top surface having a plurality of threaded members, a plurality of nuts having threads that mate with the threaded members, and a mount having a plurality of apertures that align with the plurality of threaded members and a mechanical connector for attaching the mount to a support so that the mount can be attached to the support first and then the housing can be attached to mount.

In accordance with the present invention there is also provided a surveillance camera comprising a housing having a top surface with a plurality of threaded members, a camera positioned in the housing, a plurality of nuts having threads that mate with the threaded members, and a mount having a mechanical connector for attaching the mount to a support and having a plurality of elongated apertures that align with the plurality of threaded members. The elongated apertures having first and second aperture portions with the first aperture portion being sized so that one of the nuts can pass through it and a second aperture portion being sized so that one of the nuts cannot pass through it.

In addition, the present invention provides a surveillance camera comprising a housing having a top surface with a plurality of threaded apertures, a camera positioned in the housing, a plurality of members having threads that mate with the apertures and a head that is larger than the threads, and a mount with a mechanical connector for attaching said mount to a support and a plurality of elongated apertures that align with the plurality of heads of the members. The elongated apertures have first and second aperture portions with the first aperture portion being sized so that one of the heads can pass through it and the second aperture portion being sized so that one of the heads cannot pass through it.

In another embodiment the present invention provides a surveillance camera comprising a mount having a plurality of apertures and a mechanical connector for attaching said mount to a support, a plurality of threaded members sized so that the threaded portion passes through the apertures, a plurality of nuts having threads that mate with the threaded members, and a housing having a plurality of elongated apertures that align with the plurality of threaded members, and a camera positioned in the housing. The elongated apertures having first and second aperture portions with the first aperture portion being sized so that one of the nuts can pass through it and the second aperture portion being sized so that one of the nuts cannot pass through it. The housing has a plurality of threaded apertures positioned below the second aperture portions with threads that mate with the threaded members.

In still another embodiment the present invention provides a surveillance camera comprising a mount having a plurality of apertures and a mechanical connector for attaching the mount to a support, a plurality of threaded members sized so that the threaded portion passes through the apertures, a plurality of nuts having threads that mate with the threaded members, a housing for a surveillance camera with a plurality of elongated apertures that align with the plurality of threaded members, and a camera positioned in the housing. The elongated apertures are sized so that the threaded portion of the threaded members can pass through the elongated aperture but the nuts cannot pass through it. The housing has a plurality of threaded apertures positioned below the elongated apertures with threads that mate with the threaded members.

In yet another embodiment, the present invention provides a surveillance camera comprising a housing with a top surface having a plurality of threaded members, a camera positioned in the housing, a plurality of nuts having threads that mate with the threaded members, and a mount having a plurality of apertures that align with the plurality of threaded members and a mechanical connector for attaching the mount to a support so that the mount can be attached to the support first and then the housing can be attached to mount.

Other advantages and applications of the present invention will be made apparent by the following detailed description of the preferred embodiment of the invention.

### BRIEF DESCRIPTION OF THE DRAWINGS

FIG. 1 is an elevational side view of a surveillance camera utilizing the present invention.

FIG. 2 is a perspective view of the housing of the surveillance camera shown in FIG. 1.

FIG. 3 is a perspective view of the mount of the surveillance camera shown in FIG. 1.

FIG. 4 is a perspective view of a portion of the mount and housing of the surveillance camera shown in FIG. 1 before the housing has been rotated.

FIG. 5 is a perspective view of a portion of the mount and housing of the surveillance camera shown in FIG. 1 after the housing has been rotated.

FIG. 6 is a perspective view of the mount and housing of the surveillance camera shown in FIG. 1 before the housing has been rotated.

FIG. 7 is a perspective view of the mount and housing of the surveillance camera shown in FIG. 1 after the housing has been rotated.

FIG. 8 is a perspective view of an alternative embodiment of the present invention.

FIG. 9 is a perspective view of an alternative embodiment of the mount of the present invention.

FIG. 10 is a side view of an alternative embodiment of the mount of the present invention.

FIG. 11 is a side view of an alternative embodiment of the housing of the present invention.

FIG. 12 is a partial cross-sectional view of the alternative embodiment of the housing shown in FIG. 11.

FIG. 13 is a partial cross-sectional view of the alternative embodiment of the housing shown in FIG. 11.

FIG. 14 is a partial cross-sectional view of the alternative embodiment of the housing shown in FIG. 11.

### DETAILED DESCRIPTION OF THE INVENTION

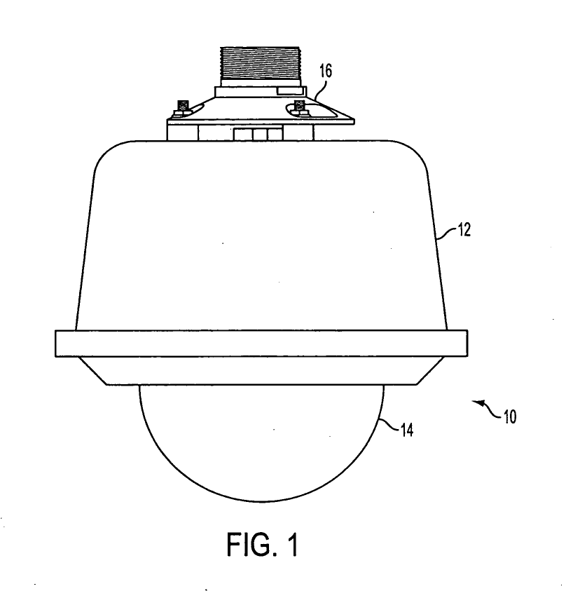

Referring to FIG. 1, a surveillance camera 10 is shown with a housing 12, transparent dome 14, and mount 16. A camera and lens assembly, not shown, is positioned inside housing 12 and can be fixed or movable so that it can be panned and tilted to provide a controllable field of view through dome 14.

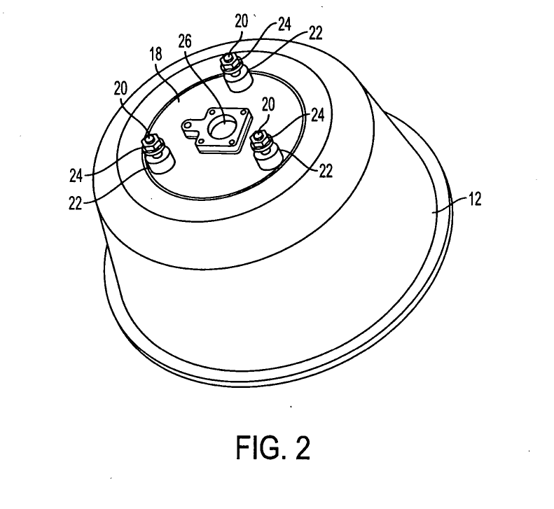

FIG. 2 shows top portion 18 of housing 12 having three threaded studs 20 protruding from three stud holders 22. Stud holders 22 can be appropriately threaded to mate with the threads of studs 20, or studs 20 can be fastened to stud holders 22 or to top portion 18 directly by welding or other suitable methods. Stud holders 22 have been shown as protruding from top portion 18; however, a portion or the entire surface of top portion 18 can be made thicker so that stud holders 22 do not protrude. Nuts 24 are shown loosely mounted on studs 20 for attachment to mount 16 as explained below. Top portion 18 has an aperture 26 through which control and data wiring, not shown, can be provided to the camera and lens assembly. Three studs 20 and stud holders 22 are shown in FIG. 2; however, two or more may be used.

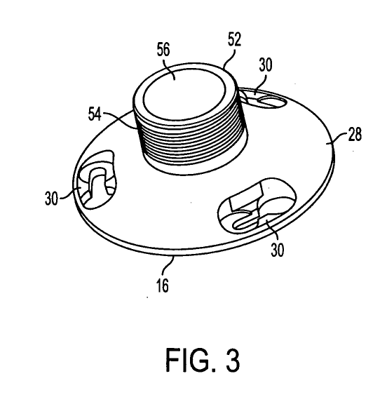

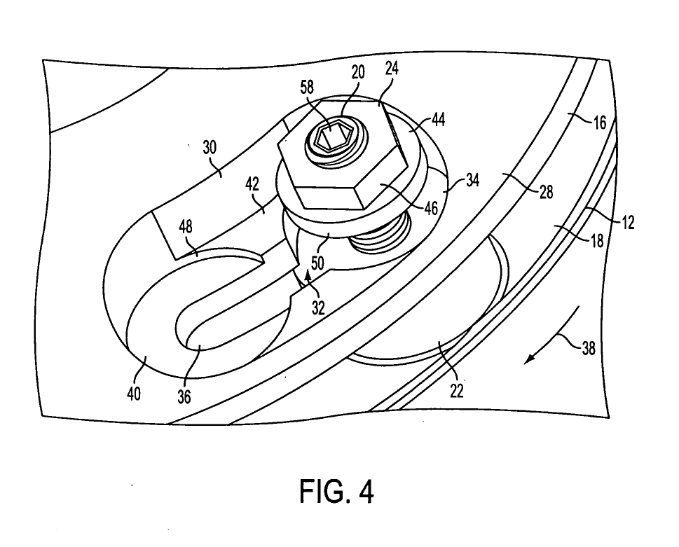

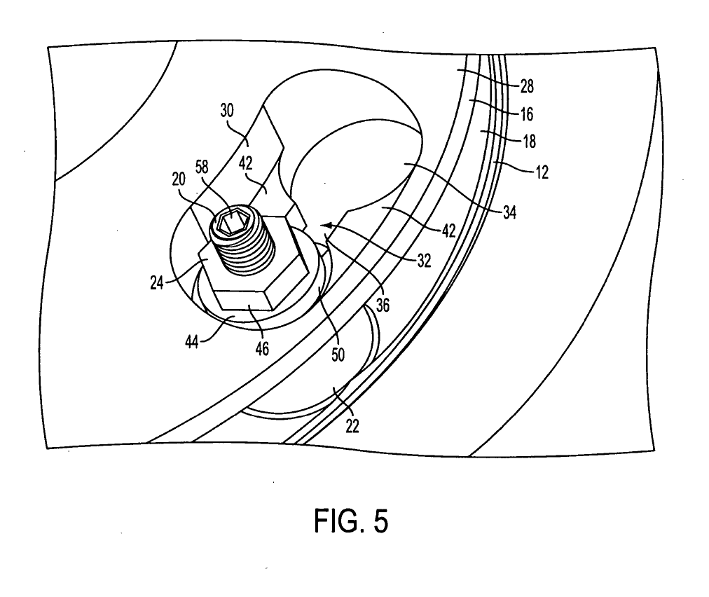

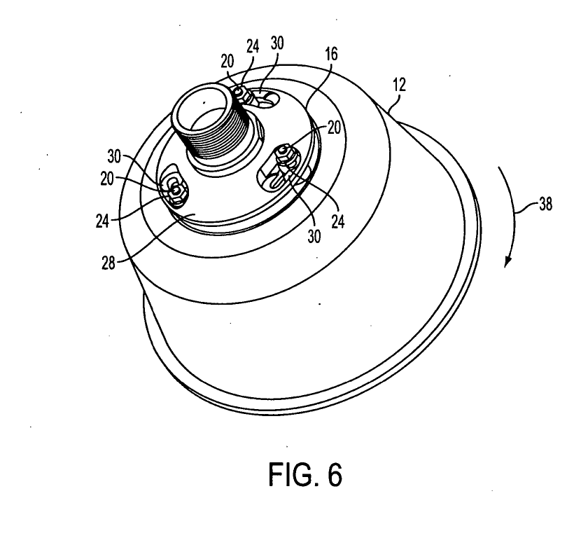

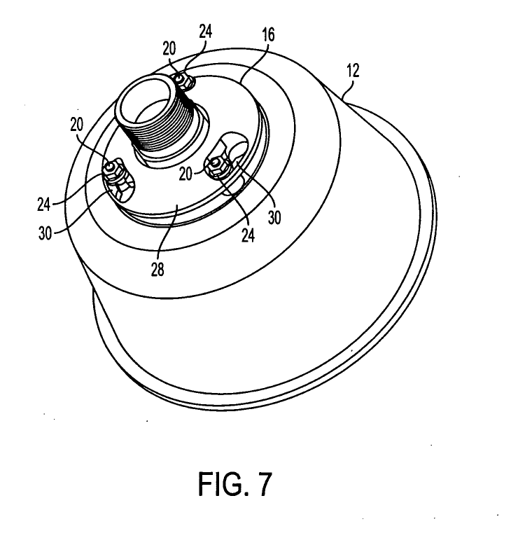

Mount 16 and its operation with and connection to housing 12 are shown in detail in FIGS. 3-7. Surface 28 has three elongated recessed areas 30, each of which has a keyhole-shaped aperture 32. Elongated recessed areas 30 are positioned around surface 28 so that keyhole-shaped apertures 32 line up with studs 20. Keyhole-shaped aperture 30 has a larger portion 34 sized to allow nut 24 to pass through and a narrow slot portion 36 sized to allow stud 20 to be moved therein, but small enough so that nut 24 cannot pass through. Elongated recessed area 30 has a recessed area 40 located at the end of slot portion 36 that is sized at least slightly larger than the diameter of nut 24. Elongated recessed area 30 has a non-recessed area 42 that is located between larger portion 34 and recessed area 40. Nut 24 has a cylindrical portion 44 and a hexagonal portion 46 for use with a wrench or socket wrench. After nuts 24 have been passed through larger portion 34, housing 12 can be rotated approximately 5 to 10 degrees clockwise as shown by arrow 38. When housing 12 has been rotated so that stud 20 is at the end of slot portion 36, nut 24 falls into recessed area 40. Wall 48 of recessed area 40 contacts wall 50 of cylindrical portion 44 of nut 24 if housing 12 is rotated counterclockwise so that an installer can release his grip of housing 12 and use a wrench to tighten nuts 24 to securely attach housing 12 to mount 16.

Mount 16 has a pipe section 52 with threads 54 and an aperture 56 positioned to align with aperture 26 in top portion 18 of housing 12 to accommodate the control and data wiring to the camera and lens assembly when mount 16 is attached to housing 12 by studs 20 and nuts 24. Threads 54 on pipe section 52 are sized to comply with industry standard pipe threading, for example, 1.5″ NPT (National Pipe Threads) so that pipe section 52 can be screwed into a female pipe fitting with similar threading. This female pipefitting could be part of a ceiling mount, pole, arm or other support structure. Stud 20 can have a socket 58 which can be, for example, hexagonal in shape for use with an Allen wrench to facilitate installation of stud 20 into stud holder 22 in the embodiment in which stud holders 22 are threaded.

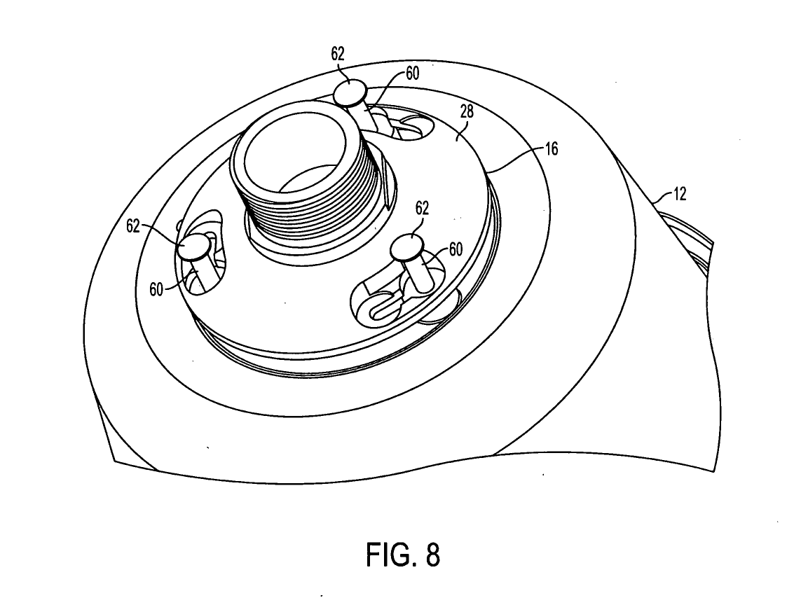

An alternative embodiment of the present invention is shown in FIG. 8 where studs 20 and nuts 24 have been replaced by fasteners 60 which have heads 62 that can be for example square or hexagonal in shape to accommodate a wrench or slotted to accommodate a screwdriver. Heads 62 fall into recessed areas 40 when housing 12 is rotated as described previously.

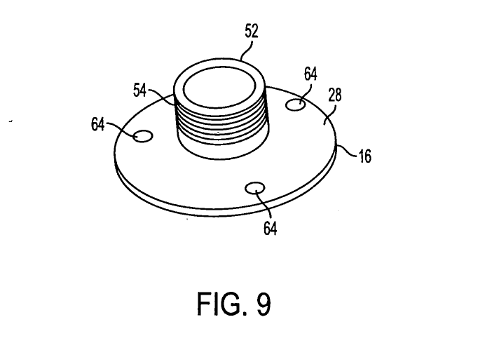

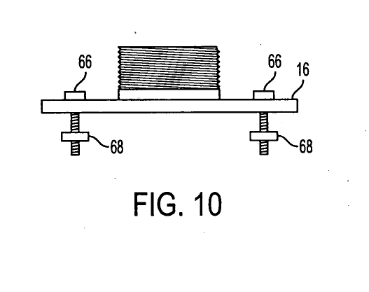

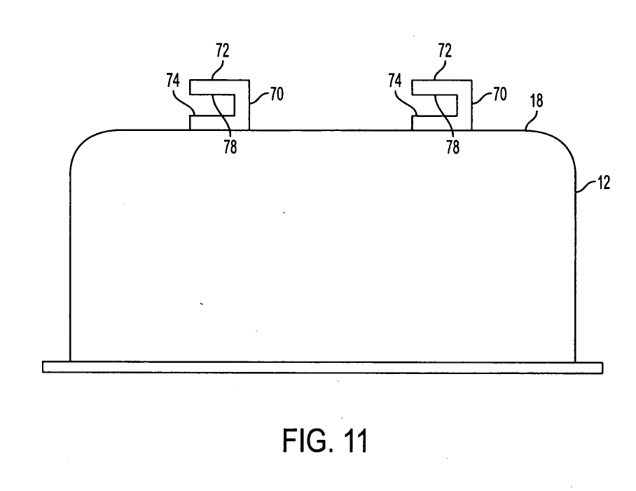

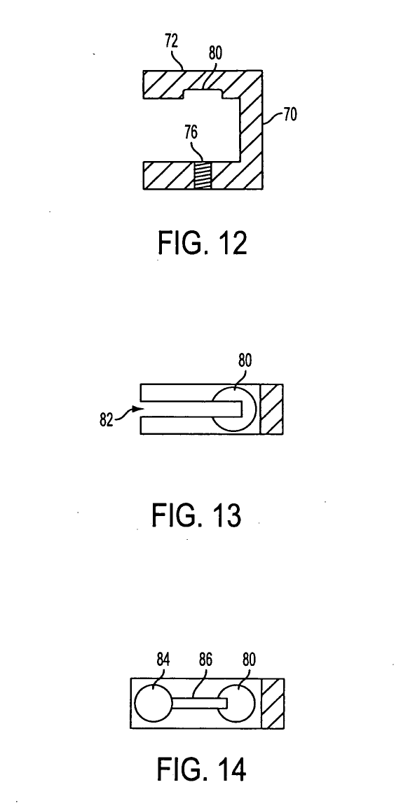

Another alternative embodiment of the present invention is shown in FIGS. 9-13. Mount 16 has three apertures 64 on surface 28 that are sized to accommodate threaded bolts 66. After bolts 66 are inserted into apertures 64, nuts 68 are partially threaded onto bolts 66. Housing 12 has holders 70 that are attached to top portion 18. Each holder 70 has an upper arm 72 and a lower arm 74, which has a threaded aperture 76 sized to mate with the threads of bolt 66. Lower surface 78 of upper arm 72, has a recessed portion 80, which is sized to accommodate nut 68 so that when housing 12 is rotated nuts 68 move into recessed portion 80 to facilitate installation as described above. Upper arm 72 can have an aperture 82, which is sized to accommodate the threaded section of bolt 66, as shown in FIG. 12 or a large aperture 84, which is sized to accommodate nut 68 and a smaller aperture or slot 86, which is sized to accommodate the threaded section of bolt 66. Alternatively, mount 16 as shown in FIG. 9 could be used with housing 12 shown in FIG. 2. In this case pipe section 52 of mount 16 is first be screwed into a suitable support structure. Studs 20 of housing 12 are then inserted through apertures 64 of mount 16 and nuts 24 are threaded onto studs 20 and tightened.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

1. A surveillance camera mount assembly for attaching a surveillance camera to a support, said assembly comprising:
a housing for a surveillance camera, said housing having a top surface with a plurality of threaded members;
a plurality of nuts having threads that mate with said threaded members; and
a mount having a mechanical connector for attaching said mount to a support, said mount having a plurality of elongated apertures that align with said plurality of threaded members, said elongated apertures having first and second aperture portions, said first aperture portion being sized so that one of said nuts can pass through said first aperture portion and said second aperture portion being sized so that one of said nuts cannot pass through said second aperture portion.

2. A surveillance camera mount assembly as recited in claim 1, wherein the top surface of said mount surrounding said second aperture portion has a recess so that when one of said nuts is passed through said first aperture portion and moved from said first aperture portion to said second aperture portion said one of said nuts will fall into said recess.

3. A surveillance camera mount assembly as recited in claim 1, wherein said top surface of said housing has a plurality of raised areas and said members extend from said raised areas.

4. A surveillance camera mount assembly as recited in claim 3, wherein said plurality of raised areas have threaded apertures that mate with said threaded members.

5. A surveillance camera mount assembly as recited in claim 1, wherein said members have an aperture in one end sized to mate with a wrench to facilitate installation of said members.

6. A surveillance camera mount assembly as recited in claim 1, wherein said mount has three elongated apertures, and said housing has three threaded members.

7. A surveillance camera mount assembly as recited in claim 2, wherein said mount has three elongated apertures, and said housing has three threaded members.

8. A surveillance camera mount assembly as recited in claim 7, wherein said top surface of said housing has a plurality of raised areas and said members extend from said raised areas.

9. A surveillance camera mount assembly for attaching a surveillance camera to a support, said assembly comprising:
a housing for a surveillance camera, said housing having a top surface with a plurality of threaded apertures and a plurality of members having threads that mate with said apertures and a head, said head being larger than said threads; and
a mount having a mechanical connector for attaching said mount to a support, said mount having a plurality of elongated apertures that align with said plurality of heads of said members said elongated apertures having first and second aperture portions with said first aperture portion being sized so that one of said heads can pass through said first aperture portion and said second aperture portion being sized so that one of said heads cannot pass through said second aperture portion.

10. A surveillance camera mount assembly as recited in claim 9, wherein said heads have a hexagonal shape.

11. A surveillance camera mount assembly as recited in claim 9, wherein said heads have a slot.

12. A surveillance camera mount assembly as recited in claim 9, wherein said mount has three elongated apertures, and said housing has three threaded members.

13. A surveillance camera mount assembly as recited in claim 12, wherein said heads have a hexagonal shape.

14. A surveillance camera mount assembly for attaching a surveillance camera to a support, said assembly comprising:
a mount having a plurality of apertures and a mechanical connector for attaching said mount to a support;
a plurality of threaded members sized so that the threaded portion passes through said apertures;
a plurality of nuts having threads that mate with said threaded members; and
a housing for a surveillance camera, said housing having a plurality of elongated apertures that align with said plurality of threaded members, said elongated apertures having first and second aperture portions, said first aperture portion being sized so that one of said nuts can pass through said first aperture portion and said second aperture portion being sized so that one of said nuts cannot pass through said second aperture portion, said housing having a plurality of threaded apertures positioned below said second aperture portions, said threaded apertures having threads that mate with said threaded members.

15. A surveillance camera mount assembly as recited in claim 14, wherein said plurality of elongated apertures are located in a raised portion of said mount, the bottom surface of said raised portion surrounding said second aperture portion of said elongated apertures has a recess so that when one of said nuts is passed through said first aperture portion and moved from said first aperture portion to said second aperture portion said one of said nuts will move into said recess when said housing is rotated.

16. A surveillance camera mount assembly for attaching a surveillance camera to a support, said assembly comprising:
a mount having a plurality of apertures and a mechanical connector for attaching said mount to a support;
a plurality of threaded members sized so that the threaded portion passes through said apertures;
a plurality of nuts having threads that mate with said threaded members; and
a housing for a surveillance camera, said housing having a plurality of elongated apertures that align with said plurality of threaded members, said elongated apertures being sized so that said threaded portion of said threaded members can pass through said elongated aperture but said nuts cannot pass through said elongated aperture, said housing having a plurality of threaded apertures positioned below said elongated apertures, said threaded apertures having threads that mate with said threaded members.

17. A surveillance camera mount assembly as recited in claim 16, wherein said plurality of elongated apertures are located in a raised portion of said mount and the bottom surface of said raised portion has a recess so that said nuts move into said recess when said housing is rotated.

18. A surveillance camera mount assembly for attaching a surveillance camera to a support, said assembly comprising:
a housing for a surveillance camera, said housing having a top surface with a plurality of threaded members;
a plurality of nuts having threads that mate with said threaded members; and
a mount having a plurality of apertures that align with said plurality of threaded members and a mechanical connector for attaching said mount to a support so that said mount can be attached to the support first and then said housing can be attached to said mount.

19. A surveillance camera mount assembly as recited in claim 18, wherein said housing has three threaded members and said mount has three apertures.

20. A surveillance camera comprising:
a housing having a trim ring and dome assembly on the bottom end and a top surface with a plurality of threaded members;
a camera positioned in said housing;
a plurality of nuts having threads that mate with said threaded members; and
a mount having a mechanical connector for attaching said mount to a support, said mount having a plurality of elongated apertures that align with said plurality of threaded members, said elongated apertures having first and second aperture portions, said first aperture portion being sized so that one of said nuts can pass through said first aperture portion and said second aperture portion being sized so that one of said nuts cannot pass through said second aperture portion.

21. A surveillance camera as recited in claim 20, wherein the top surface of said mount surrounding said second aperture portion has a recess so that when one of said nuts is passed through said first aperture portion and moved from said first aperture portion to said second aperture portion said one of said nuts will fall into said recess.

22. A surveillance camera as recited in claim 20, wherein said top surface of said housing has a plurality of raised areas and said members extend from said raised areas.

23. A surveillance camera as recited in claim 22, wherein said plurality of raised areas have threaded apertures that mate with said threaded members.

24. A surveillance camera as recited in claim 20, wherein said members have an aperture in one end sized to mate with a wrench to facilitate installation of said members.

25. A surveillance camera as recited in claim 20, wherein said mount has three elongated apertures, and said housing has three threaded members.

26. A surveillance camera as recited in claim 21, wherein said mount has three elongated apertures, and said housing has three threaded members.

27. A surveillance camera as recited in claim 26, wherein said top surface of said housing has a plurality of raised areas and said members extend from said raised areas.

28. A surveillance camera comprising:
a housing having a trim ring and dome assembly on the bottom end and a top surface with a plurality of threaded apertures and a plurality of members having threads that mate with said apertures and a head, said head being larger than said threads;
a camera positioned in said housing; and
a mount having a mechanical connector for attaching said mount to a support, said mount having a plurality of elongated apertures that align with said plurality of heads of said members said elongated apertures having first and second aperture portions with said first aperture portion being sized so that one of said heads can pass through said first aperture portion and said second aperture portion being sized so that one of said heads cannot pass through said second aperture portion.

29. A surveillance camera as recited in claim 28, wherein said heads have a hexagonal shape.

30. A surveillance camera as recited in claim 28, wherein said heads have a slot.

31. A surveillance camera as recited in claim 28, wherein said mount has three elongated apertures, and said housing has three threaded members.

32. A surveillance camera as recited in claim 31, wherein said heads have a hexagonal shape.

33. A surveillance camera comprising:
a mount having a plurality of apertures and a mechanical connector for attaching said mount to a support;
a plurality of threaded members sized so that the threaded portion passes through said apertures;
a plurality of nuts having threads that mate with said threaded members; and
a housing having a plurality of elongated apertures that align with said plurality of threaded members, said elongated apertures having first and second aperture portions, said first aperture portion being sized so that one of said nuts can pass through said first aperture portion and said second aperture portion being sized so that one of said nuts cannot pass through said second aperture portion, said housing having a plurality of threaded apertures positioned below said second aperture portions, said threaded apertures having threads that mate with said threaded members;
and a camera positioned in said housing.

34. A surveillance camera as recited in claim 33, wherein said plurality of elongated apertures are located in a raised portion of said mount, the bottom surface of said raised portion surrounding said second aperture portion of said elongated apertures has a recess so that when one of said nuts is passed through said first aperture portion and moved from said first aperture portion to said second aperture portion said one of said nuts will move into said recess when said housing is rotated.

35. A surveillance camera comprising:
a mount having a plurality of apertures and a mechanical connector for attaching said mount to a support;
a plurality of threaded members sized so that the threaded portion passes through said apertures;
a plurality of nuts having threads that mate with said threaded members; and
a housing having a plurality of elongated apertures that align with said plurality of threaded members, said elongated apertures being sized so that said threaded portion of said threaded members can pass through said elongated aperture but said nuts cannot pass through said elongated aperture, said housing having a plurality of threaded apertures positioned below said elongated apertures, said threaded apertures having threads that mate with said threaded members; and
a camera positioned in said housing.

36. A surveillance camera as recited in claim 35, wherein said plurality of elongated apertures are located in a raised portion of said mount and the bottom surface of said raised portion has a recess so that said nuts move into said recess when said housing is rotated.

37. A surveillance camera comprising:
a housing having a trim ring and dome assembly on the bottom end and a top surface with a plurality of threaded members;
a camera positioned in said housing;
a plurality of nuts having threads that mate with said threaded members; and
a mount having a plurality of apertures that align with said plurality of threaded members and a mechanical connector for attaching said mount to a support so that said mount can be attached to the support first and then said housing can be attached to said mount.

38. A surveillance camera as recited in claim 37, wherein said housing has three threaded members and said mount has three apertures.
